(19) United States
(12) Patent Application Publication
(10) Pub. No.: US 2011/0145728 A1
(43) Pub. Date: Jun. 16, 2011

(54) RICH CONTENT MANAGER (RCM)

(76) Inventor: Monika Bishop, Hendersonville, TN (US)

(21) Appl. No.: 12/639,909

(22) Filed: Dec. 16, 2009

(51) Int. Cl. G06F 15/16; G06F 3/01; G06F 17/30

(52) U.S. Cl. 715/760; 709/203; 707/769; 707/802; 707/E17.044; 707/E17.108; 707/705

(57) ABSTRACT

A system for delivering multimedia content over a network to a client browser is disclosed. The system includes a first hypertext transfer protocol server, a database server in which the multimedia content is stored in a structured arrangement, and an application server that is in communication with the hypertext transfer protocol server and the database server. A remote application that includes a controller module, a persistence module, and a browser interface module is executable on the application server. The multimedia content corresponding to selection input from the browser is retrievable with a query from the controller module to the persistence module. A multimedia playback interface generated by the browser interface module replays the multimedia content. The interface is embedded within a document generated by the second hypertext transfer protocol server.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention relates generally to networked data processing, and more particularly, to a multimedia content management system.

2. Related Art

The World Wide Web (WWW or Web) is one of the most widely utilized services of the global Internet. Because the Web is such a substantial part of the Internet, the two terms are oftentimes used interchangeably. Presently, the Web is used for e-commerce, where payments are accepted for the exchange of various goods and services, news and information delivery, social networking, communication, and entertainment, among any others.

Generally, the Web is a vast collection of interconnected or hyperlinked documents referred to as web pages that are accessed with a user agent such a general-purpose web browser application. Earlier, web pages were simple text documents encoded in the HyperText Markup Language (HTML) and stored as individual files on a Web server. As the volume of data and the degree of particularized information delivery increased, however, server-end features to generate custom web pages from user-submitted queries were developed. The tags with which the HTML files were encoded, when processed by the browser application, caused the document to be rendered in a predefined manner. In addition, the web pages typically contained user-selectable links, known as hyperlinks, to other documents available on the Web.

Further developments in web browsers enabled the display of graphical images in-line with the text. Nevertheless, such earlier web browsers were nothing more than static document viewers. As such, the interactivity level of the web remained low. In response to the ever-increasing need to deliver additional interactivity over the Web, scripting functionality such as JavaScript and VBScript was added. Besides graphical images, a variety of multimedia content such as audio, video, vector animations, and the like may be delivered to the browser and displayed thereon by external modules known as plug-ins or add-ons. Popular multimedia playback plug-ins include QuickTime from Apple Corporation, RealPlayer from RealNetworks, Inc., and Shockwave Flash from Adobe Systems, Inc.

It is well recognized that in order to attract and maintain an audience, web content must be constantly updated with new information and corrections. When web sites were of minimal complexity and consisted of static HTML files, modifications were typically made by one manager, sometimes referred to as a webmaster. With a higher volume of content being published on websites, however, the involvement of additional contributors became necessary, particularly because of the speed with which updates were required to be made and the need for strict quality control. In some instances, individual contributors were solely responsible for a specific subsection of the website, but it remains more often the case that multiple contributors would be editing a single document, sometimes simultaneously.

When working directly with static files, it was necessary for the content producer to be well-versed in HTML, and was aware of the aesthetic considerations in designing web pages. Along with the segregation of contributors along the different subsections of the website, the development of features that better separated content production, presentation, and back-end application logic led to the division of labor between content producers, graphics designers, and programmers, respectively.

In this environment, a need for systems that streamlined the workflow of generating, editing, and publishing web content arose. There are a number of web-specific content management systems, such as Vignette Content Management from Open Text Corporation and TeamSite from Interwoven Incorporated.

The proliferation of broadband Internet has made feasible the delivery of multimedia content such as video and audio, whereas previously, it was impractical due to the lack of available bandwidth. This, in turn, increased the demand for various websites to provide such multimedia content in order to remain competitive in maintaining the interest of the users. Unlike the management of basic assets such as text and graphics, there are a number of complexities associated with providing multimedia content online. For instance, video and audio data can be encoded and compressed in a variety of formats that requires a unique decoder installed on the browser end, as noted above. Moreover, because there is no textual content in such video and audio files for a search engine to index, accessibility dictates that the multimedia content be labeled and organized properly. Along these lines, it may be desirable to restrict access to certain content while others are publicly available.

While it is possible to add multimedia content delivery capabilities to existing web sites, appropriate content management systems are expensive and time-consuming to set up and maintain. Many conventional websites are hosted internally, and the upload bandwidth allocation from the Internet Service Provider (ISP) may be limited. Thus, the size/quality of the content delivered may be restricted, and/or delivery of the content may have to be temporarily suspended. While spikes in demand may be handled without issue by the ISP, the organization may have to pay substantial overage fees unless it is unable to anticipate the increase and upgrade service levels ahead of time. This is likely to be an issue when multimedia content experiences sudden widespread popularity, e.g., viral videos.

Accordingly, there is a need in the art for an improved multimedia content management and delivery system.

### BRIEF SUMMARY

In accordance with one embodiment of the present invention, a system for delivering multimedia content over a network to a client browser is contemplated. The system may include a first hypertext transfer protocol server that is connected to the network and is in communication with the client browser. Additionally, the system may include a database server in which the multimedia content is stored in a structured arrangement. The system may also include an application server that is in communication with the hypertext transfer protocol server and the database server. A remote application may be executable on the application server, which may include a controller module, a persistence module, and a browser interface module. The controller module may be receptive to selection input from the client browser, while the persistence module may interface the controller module to the structured arrangement in the database server. The multimedia content corresponding to the selection input may be retrievable with a query from the controller module to the persistence module. The browser interface module may generate a multimedia playback interface rendered by the client browser. The retrieved multimedia content may be transmitted to the client browser and displayed within the rendered multimedia playback interface. The remote application may be linkable from a cooperating second hypertext transfer protocol server, and the multimedia playback interface may be embeddable within a document that is generated by the second hypertext transfer protocol server and rendered by the client browser.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram of an exemplary environment within which various embodiments of a multimedia content management and delivery system of the present invention may be deployed;

FIG. 2 is a detailed block diagram of one embodiment of the multimedia content management and delivery system;

FIG. 3 is a block diagram illustrating another embodiment of the multimedia content management and delivery system in which two separate websites have independent media centers associated therewith;

FIG. 4 is an illustration of the content storage tables defined in a database of the multimedia content management and delivery system and their interrelationships;

FIG. 5 is an illustration of the media center definition tables of the database;

FIG. 6 is an illustration of the user management definition tables of the database; and

FIG. 7 is an exemplary user interface of the multimedia content management and delivery system as rendered by a client browser application.

Common reference numerals are used throughout the drawings and the detailed description to indicate the same elements.

### DETAILED DESCRIPTION

The detailed description set forth below in connection with the appended drawings is intended as a description of the presently preferred embodiment of the invention, and is not intended to represent the only form in which the present invention may be developed or utilized. The description sets forth the functions of the invention in connection with the illustrated embodiment. It is to be understood, however, that the same or equivalent functions may be accomplished by different embodiments that are also intended to be encompassed within the scope of the invention. It is further understood that the use of relational terms such as first and second and the like are used solely to distinguish one from another entity without necessarily requiring or implying any actual such relationship or order between such entities.

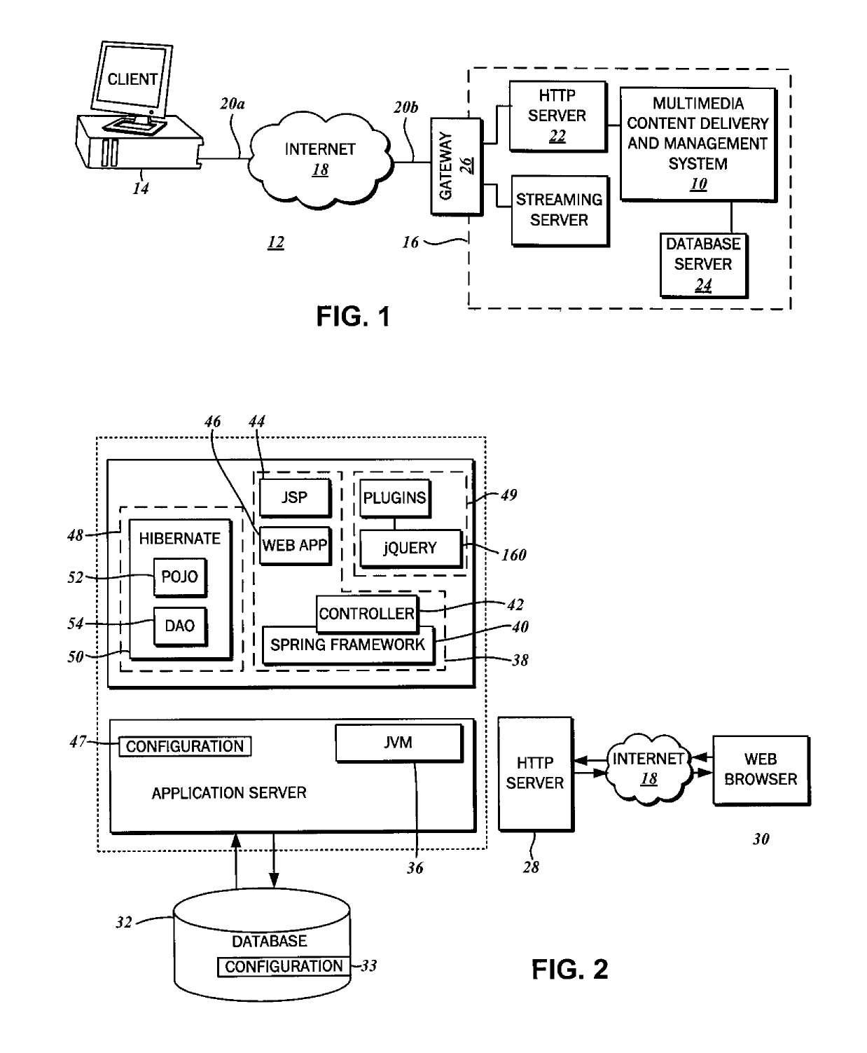

With reference to the block diagram of FIG. 1, the present invention generally contemplates a multimedia content delivery and management system 10 that is deployed in a first exemplary networked computing environment 12. In a simplified depiction, there is a client computer 14 that is capable of communicating with a server subnetwork 16 and the multimedia content delivery and management system 10. The client computer system 14, which is presented by way of example only, may be a conventional desktop computer having a central processing unit, memory, and input and output devices connected thereto such as keyboards, mice, and display units. The client computer system 14 is linked to the server subnetwork 16 and the multimedia content delivery and management system 10 over a wide area network such as the Internet 18 via a first network connection 20a. Those having ordinary skill in the art will recognize that there are numerous possible variations with regard to the hardware devices that comprise the client computer system 14 and the modalities by which it connects to the Internet 18. Alternatives to the desktop computer include mobile devices such as smart phones, laptop computers, and the like.

In the context of the exemplary network computing environment 12, the term “client” is understood to refer to the role of the client computer system 14 as a requestor of data or services, while the term “server” is understood to refer to the role of the server subnetwork 16 to provide such data or services. There are a number of components that are a part of the server subnetwork 16, and specific reference thereto will be made as applicable. It is possible that the components of the server subnetwork 16 may request data or services in one transaction, and provide data or services in a different transaction. The server subnetwork 16 is also connected to the Internet 18 via a second network connection 20b.

Specifically, the server subnetwork 16 is contemplated to host a website that is accessible from the Internet 18, and is associated with one organizational entity that is distinct and apart from that associated with the multimedia content delivery and management system 10. As noted above, one deficiency associated with hosting multimedia files from the server subnetwork 16 is the limited bandwidth capacity of the second network connection 20a particularly for those organizational entities that in general do not serve a large volume of data on a regular basis or that do not have the financial resource to pay for the same. Thus, the multimedia content delivery and management system 10 of the present invention may be external to the server subnetwork 16. In some embodiments, however, the multimedia content delivery and management system 10 may be internal to, and co-managed with, the server subnetwork 16 as shown in FIG. 1 As network bandwidth becomes more available, it is anticipated that pricing will decrease, making such deployments more feasible.

The server subnetwork 16 may include a web server 22 and an optional database server 24 that are both connected to a gateway 26. Local area network traffic from the web server 22 and the database server 24 bound for the Internet 18 are handled by the gateway 26, which routes the same to the second network connection 20b. Along these lines, traffic from the Internet 18 is received by the gateway 26 and routed to the specified destination.

The client computer 14 is understood to have software instructions loaded thereon that, when executed, perform various functions in accordance with the various embodiments of the present invention. By way of example only and not of limitation, the client computer system 14 has a web browser application such as Internet Explorer from Microsoft Corporation of Redmond, Wash., or Firefox from the Mozilla Foundation that communicate with the web server 22. Various versions of these web browser applications may be utilized, in addition to others such as Chrome from Google, Inc. of Mountain View, Calif., Safari from Apple, Inc. of Cupertino, Calif., etc. As noted above, the client computer system 14 may be any one of a variety of computing devices, and it is understood that such computing devices have specialized web browser applications that function in essentially the same way.

Generally, the web browser application requests data as specified in a Uniform Resource Locator (URL), part of which specifies the address of the web server 22, another part of which specifies a particular file on the web server 22, and another part of which specifies parameters to an executable routine if that file is an executable script receptive to such parameters. The requested data, whether in the form of a static page or as dynamic information generated by web server 22, is formatted according to the Hypertext Markup Language (HTML) for rendering by the web browser application for viewing by the user. The web page may include text, graphics, audio, video, browser-executable scripts and compiled modules, all of which are rendered within the web browser application; any reference to the web page herein is understood to also include such other files that are not embedded within the file of the web page itself, but are directly referenced as a part of the web page. Further details regarding the functionality of the web browser application as relating to the multimedia content delivery and management system 10 will be discussed below.

As best illustrated in the block diagram of FIG. 2, the multimedia content delivery and management system 10 includes a first hypertext transfer protocol (HTTP) server 28 that is connected to the Internet 18 and is communicating with the web browser application 30. It is understood that the first HTTP server 28 functions in essentially the same way as the web server 22 that is part of the server subnetwork 16, in that the particular data requested via the specified URL is transmitted back to the web browser application 30 for rendering thereby. According to one embodiment of the present invention, the first HTTP server 28 is the Apache HTTP Server. It will be appreciated that any other HTTP server including those that are derived from the Apache codebase such as the IBM HTTP server that is a part of the IBM WebSphere Aplication Server, may also be utilized.

The multimedia content delivery and management system 10 also includes a database server 32, which stores multimedia content in a structured arrangement. In this regard, the administrative functionality of the multimedia content delivery and management system 10 described below may be generally referred to as a digital asset management system (DAMS). As utilized herein, multimedia content refers to video files, audio files, animation files, slideshow/presentation files, word processing documents, and any other data that is handled by the multimedia content delivery and management system 10. According to one embodiment, the database server 32 is the DB2 relational database management system, also available from International Business Machines Corp. Although any suitable structured arrangement may be implemented, in the particular embodiment utilizing DB2, it is understood to be a relational database, where data is represented as a set or table of rows and columns. Additional specificities with respect to the data structures and entities stored in the database server 32 will be described below.

Another component of the multimedia content delivery and management system 10 is an application server 34 in communication with the database server 32 and the http server 28. It is contemplated that the application server 34 is the WebSphere Application Server, also from International Business Machines Corp., or any other application server that follows Java 2 Enterprise Edition (J2EE) standards. Different software components are running on the application server 34 to implement the multimedia content delivery and management system 10. Thus, while the term application server 34 is understood to refer to the hardware and software framework that enables the specific functionality of the multimedia content delivery and management system 10, it is also understood to refer generally to those additional components.

In the embodiment with the WebSphere Application Server, the application server 34 hosts a Java Virtual Machine (JVM) 36 atop which the various functional elements of the multimedia content delivery and management system 10 runs. The JVM 36 is understood to be J2EE-compliant, with a runtime environment of version 1.6 or above. As will be appreciated by those having ordinary skill in the art, virtual machine instances can be transferred from one physical server system to another, and can be run on multiple servers for increased throughput and infinite scalability, among other advantages. The software code that runs on the JVM 36 is known in the art as bytecode.

The HTTP server 28, the database server 32, and the application server 34 may each run on separate hardware systems, or may also run on a single system. There are numerous ways in which to configure these basic elements according to typical anticipated loads, available resources, and other such factors, and the particular configuration of the exemplary embodiment are not intended to be limiting. Relatedly, while the various embodiments are described in relation to specific commercially or freely available products, any available component having equivalent functionality may be readily substituted without departing from the scope of the present invention. It is understood that the various web application frameworks noted herein foster specific development practices and approaches to managing the functionality of the multimedia content delivery and management system 10. It will be understood that the substitution of one framework for another brings attendant changes to such development practices, but the underlying features of the present invention are the same or equivalent.

Having set forth the components of the multimedia content delivery and management system 10, the general functional inter-relations between the same as defined by a remote application executable on the application server 34 will now be considered. As briefly indicated above, the multimedia content delivery and management system 10 contemplates a remote application for the playback of various multimedia files that can be linked to from a web page delivered by the web server 22. Once the web browser application 30 requests that page, the user interface for the remote application is retrieved from the first HTTP server 28, which in turn requests the same be generated by the application server 34. User input provided over the web browser application 30 is transmitted to the first HTTP server 28, and processed by the application server 34.

One typical input involves the request for a specific multimedia file stored on the database server 32. The application server 34 contacts the database server 32 to request the specified data, and the first HTTP server 28 transmits the same to the web browser application 30. Utilizing one of various playback plug-in modules being executed on the web browser application 30, the retrieved multimedia file is presented within the user interface of the remote application. In addition to the playback of remotely stored multimedia files, the present invention also contemplates the management of such files via a different user interface that is similarly generated by the application server 34. Furthermore, new multimedia files may be uploaded to the database server 32 from the web browser application 30 via another user interface generated by the application server 34.

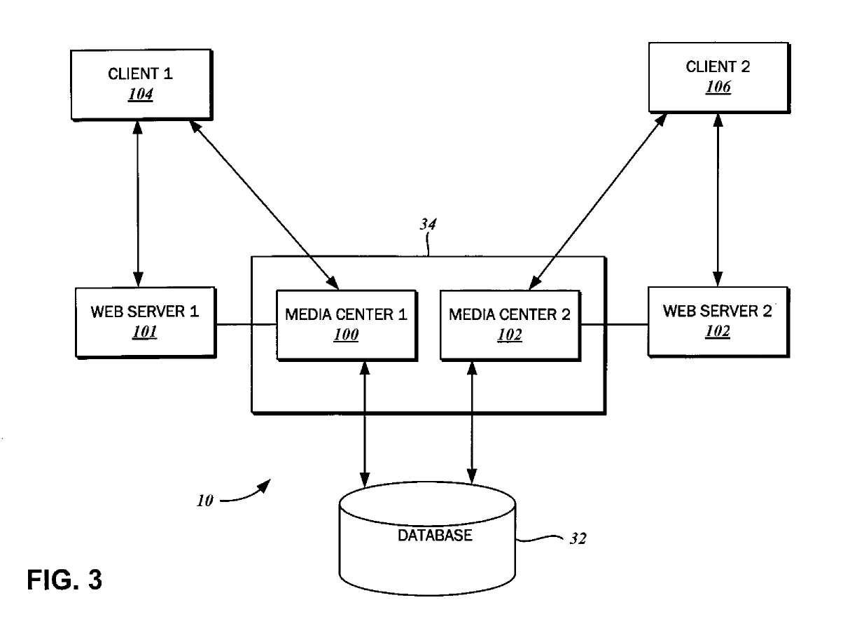

In addition to providing multimedia hosting and delivery services for one website or organization, the multimedia content delivery and management system 10 is also contemplated to provide such services simultaneously for a different website completely independent of any others. With reference to the block diagram of FIG. 3, a first “media center” 100 is designated for a first website 101, and a second “media center” 102 is designated for the second website 103. The first website 101 and the second website 103 may be independently administered. The data stored on the multimedia content delivery and management system 10 is designated as specific to one media center or another, and access is limited to users of the same.

Where a first client 104 navigates to a page on the first website 101 and requests a multimedia file, the first media center 100 retrieves the requested data from the common database server 32. In addition to locally stored data, external content from remote sites such as Ipaper, Youtube, and so forth are also supported via the integration of embed statements or streaming URLs. Also, when a second client 106 navigates to a page on the second website 103 and requests a multimedia file, the second media center 102 retrieves the requested data from the common database server 32. It is contemplated that the first client 104 is restricted from accessing multimedia content designated for the second media center 102 if the access is via the first media center 100, and vice versa. Searching, categorizing, and other organizational functions are likewise limited to within the context of a given media center. It is expressly contemplated however, that there are modalities by which multimedia content associated with one media center can shared to another media center.

The application server 34 hosts a number of software components or modules that each provides some functionality of the multimedia content delivery and management system 10. Together, these components comprise the remote application executable on the application server 34.

One of the components is a controller module 38 that provides high-level logic in coordinating the operation of the other components or modules of the remote application, including data access and user interfacing. The controller module 38 is based upon an application framework 40, which in one embodiment is the Spring framework. It will be understood that the Spring framework supports the use of declarative transaction management, remote access to application logic via Java Remote Method Invocation (RMI) or web services, and various options for persisting data to a database. Further, Spring provides a full featured Model-View-Controller (MVC) framework, in which application logic, presentation, and data access functions are segregated.

More specifically, the entry point of the remote application is a set of framework controllers 42, which are understood to process and respond to various HTTP events. According to the embodiment utilizing the Spring framework, the framework controllers 42 are built around the DispatcherServlet class, or the front controller of the framework. This dispatches requests to various handlers that have configurable handle mappings, view resolution, and locale and theme resolution. Additionally, the framework controllers 42 have support for file upload functionality. The framework controllers 42, in turn, cooperate with Java Server Pages (JSP) 44, which implement the application logic and generate dynamic content. In conjunction with the dynamic content, various web application resources 46 may also be included. These include images, cascading style sheets (CSS), JavaScript libraries, as well as resources specific to media plug-ins such as Flash (SWF) and Silverlight (XAML).

The application server 34 also hosts a number of components collectively referred to as a persistence module 48. It is understood that the persistence module 48 interfaces the controller module 38 to the structured arrangement in the database server 24. Based upon a query from the controller module 38, the persistence module retrieves the specified data. So that different data sources may be specified, the application server 34 includes configuration settings 47. Other uses for the configuration settings 47 will be explained further below.

In greater detail, the persistence module 48 includes an object-relational mapping library 50 such as Hibernate, which maps Java classes to tables on the database server 32. As noted above, the database server 32 in one embodiment is a relational database system utilizing the Structure Query Language (SQL) to retrieve and manipulate the data store therein. The object-relational mapping library 50 allows the remote application to interface with the database server 32 in terms of objects (Plain Old Java Objects, or POJO 52) via its own query service. As such, persistence classes may be developed following well-known object oriented features including association, inheritance, polymorphism, composition, and collections. Further, data access objects 54 may provide an abstract interface to the structured arrangement on the database server 32. Accordingly, rather than dealing with the specific implementation details of the database server 32 to access the data stored thereon, the remote application generically accesses a data source via the object-relational mapping library 50.

The underlying configuration and organization (schema) of the structured arrangement on the database server 32 may vary according to the particular implementation of the multimedia content delivery and management system 10. The configuration of the schema is stored in a database configuration file 33. Though specifics of such a structured arrangement in one embodiment of the present invention will now be described, it will be appreciated by those having ordinary skill in the art that such details are not limiting, and any other arrangement may be readily substituted. Along these lines, from the detailed description of the schema, it will become apparent that other functionality of the remote application besides the most basic ones noted above are possible, and are likewise contemplated as being within the scope of the present invention.

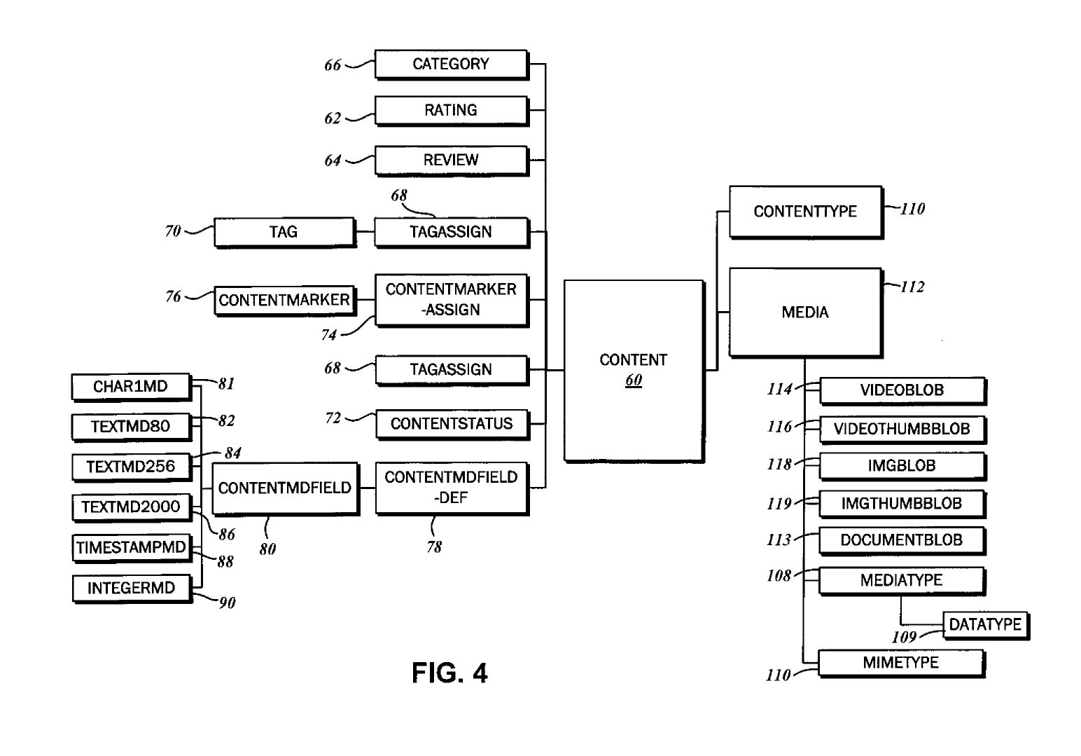

At the basic level, the database server 32 and the schema of the structured arrangement includes a configuration for storing a variety of multimedia content, in a variety of different formats, in some manner that facilitates access. Referring now to FIG. 4, the fundamental unit of storing multimedia data is the CONTENT table that is defined by one or more attributes.

Additionally, any given record of the CONTENT table may have associated therewith various other tables that define its characteristics. In this regard, a record of the CONTENT table may be linked to a RATING table 62 that allows the user to assign a numeric score thereto, typically between one and five, though any other suitable range may be utilized. Related to the RATING table 62 and having similar purposes is a REVIEW table 64, which stores written comments submitted by users. As will be recognized, multiple users can assign different ratings and add reviews for one record of the CONTENT table 60, but a single user can typically assign only one rating or review. One unstructured way of organizing multimedia content that also facilitates searching, is the assignment of contextual tags. In further detail, the CONTENT table 60 is associated with a TAGASSIGN table 68, which in turn is associated with a TAG table 70. In this configuration, multiple tags can be assigned to a single record of the CONTENT table 60, and the same tag can be assigned to multiple records of the CONTENT table 60. The assignment of other classification data is also contemplated, such as with an associated CONTENTSTATUS 72. The state of the content, i.e., completed, in progress, or not applicable, is indicated by this table.

Along these lines, different markers may be associated with the record of the CONTENT table 60. It is envisioned that such markers allow the custom definition of the classification of fields, for example, required or optional. With this data, transaction states can be assigned and tracked. A CONTENTMARKERASSIGN table 74 links a CONTENMARKER table 76 that specifies the marker to the CONTENT table 60.

According to an embodiment of the present invention, a variety of metadata may be associated with the records of the CONTENT table 60. This metadata can be text, timestamps, integers, or any other suitable information. The customized definitions of content metadata is set forth in a CONTENMDFIELDDEF table 78, the attributes of which are stored in a CONTENTMDFIELD table 80. The CONTENTMDFIELD table 80 variously stores metadata of text having different lengths from 1 character, 80 characters, 256 characters, to 2000 characters. Additionally, metadata of timestamps, as well as integers, are stored in the CONTENTMDFIELD table 80. So that multiple instances of similar categories of metadata can be stored, the attributes of the CONTENTMDFIELD table 80 are identifiers to other tables. For instance, text data of 1 character is stored in a CHAR1MD table 81, text data of 80 characters is stored in a TEXT80MD table 82, text data of 256 characters is stored in a TEXT256MD table 84, and text data of 2000 characters is stored in a TEXT2000MD table 86. Timestamps are stored in a TIMESTAMPMD table 88, and integers are stored in an INTEGERMD table 90.

The attributes of the CONTENT table 60 collectively define the inherent characteristics of the stored multimedia content. One such attribute is the assigned category, further detailed in a CATEGORY table 66. A tree-like hierarchy of categories, similar to file system directory paths, can be assigned therewith. Generally, the category is assigned by an administrator after uploading multimedia content to the database server 32. Along these lines, the type of content stored in the record of the CONTENT table 60 is defined in a CONTENTTYPE table 110. A custom definition of the various content types is stored therein, and is understood to refer to such identifiers as video, clip, movie, and so forth.

It is envisioned that the aforementioned attributes can be defined from an administrative module of the remote application, at the time the multimedia file is uploaded.

Another attribute of the CONTENT table 60 holds the reference to the stored multimedia file, and the structure contemplates the possibility of associating a plurality of multimedia files to a single record. This attribute identifies a specific record of a MEDIA table 112, which in turn includes one or more attributes that define the record. Again, the attributes of the MEDIA table 112 identify specific records of various tables that are configured to store video data, video preview data, image data, image thumbnail data, and document/text data. In this regard, a VIDEOBLOB table 114 stores the video file, which according to one embodiment, can be up to 2 gigabytes. A VIDEOTHUMBBLOB table 116 stores the preview of that video file. An IMGBLOG table 118 stores image binary data, which can be as large as 6 megabytes, and a IMGTHUMBBLOB table 119 stores a preview of up to 50 kilobytes of that image. Furthermore, a DOCUMENTBLOB table 113 stores document data of up to 20 megabytes. As utilized herein, document data refers to various binary files that are produced by, for example, word processing applications and the like. Its underlying content is text data, however.

In order to provide additional context to the remote application and to the web browser application, the MEDIA table 112 includes additional attributes that define additional characteristics of the multimedia file stored in a record thereof. One of the attributes links to a MEDIATYPE table 108. This table is understood to broadly define the multimedia file type, amongst the possible values of which include videos, images, and documents. Additionally, the MEDIATYPE table 108 defines how the multimedia file is stored and displayed, and references a DATATYPE table 109 that defines the technical specificities of the stored file. For example, the file may be characterized as a MPEG-4 compliant video data, MP3 compliant audio data, and so forth. Also related to these attributes is the MIME (Multipurpose Internet Mail Extensions) identifier for the content being stored, and is defined in a MIMETYPE table 110. It is understood that the MIME identifier is useful to identify the content type to the web browser application.

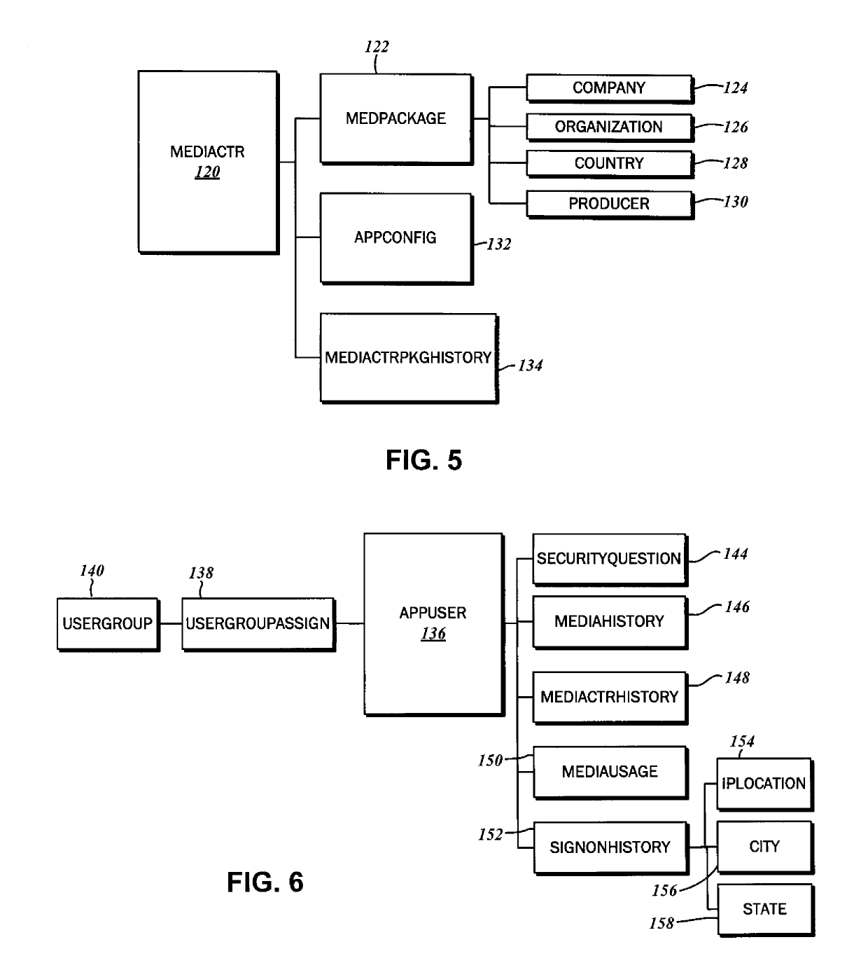

As indicated above, the multimedia content delivery and management system 10 contemplates one or more independent media centers that limits data accessibility and search context to that of the website from which it is called. Implementation of this functionality, in accordance with one embodiment, involves the storage of data pertinent thereto in the database server 32. Accordingly, with reference to the diagram of FIG. 5, the structured arrangement of the database server 32 includes a MEDIACTR table 120. It is contemplated that this table stores the definition of the media centers, including its name designators, logos, organizational information, administrative contacts, as well as system resource quotas such as file size limits, transfer bandwidth limits, and total storage limits.

In greater detail, the attributes of the MEDIACTR table 120 references other table records that store this information. These include a MEDPACKAGE table 122 that has attributes with references to records of a COMPANY table 124, an ORGANIZATION table 126, a COUNTRY table 128, and a PRODUCER table 130. The COMPANY table 124 stores the name of a company with which a particular media center is associated, while the ORGANIZATION table 126 stores the name of an organization with which a particular media center is associated. The COUNTRY table 128 stores the name of the country associated with the organization or company of the media center, and the PRODUCER table 130 stores the name of the producer associated with the particular media center. The MEDPACKAGE table 122 also includes attributes that define the disk space limitations, user number limitations, and bandwidth limits of the particular media center. These configuration settings may be utilized by a bandwidth throttling module to limit the amount of multimedia content being transferred from the multimedia content delivery and management system 10. An attribute of the MEDIACTR table 120 also references an APPCONFIG table 132 in which custom media center parameters are stored, including the aforementioned names, logos, and the like. There is also an attribute referencing a MEDIACTRPCKGHISTORY table 134 that stores the history of various upgrades and downgrades in service levels that have been made to a particular media center.

It is contemplated that the media center experience can be tailored to individual users, and the structured arrangement on the database server 32 is accordingly understood to store pertinent data therefor. Access limitations to certain content may also be enforced through the media center with the stored privilege information. Referring to FIG. 6, an APPUSER table 136 aggregates all user-specific information for the multimedia content delivery and management system 10. Various attributes of this table store e-mail addresses, password, first names, last names, company name, security questions, and so forth. In addition, there are other tables associated with a particular record of the APPUSER table 136 that provides additional convenient features, as will be considered more fully below.

Each user record is assigned to one or more groups, as specified in a USERGROUPASSIGN table 138 that references a USERGROUP table 140 to the APPUSER table 136. Various access policies may be established with user group assignments as will be readily recognized by those having ordinary skill in the art, and users of a particular group may be limited to certain media centers and certain content. Exemplary user groups may include, for example, family friends, work, marketing, and the like. Referring back to the diagram of FIG. 4, each record of the CONTENT table 60 may further include reference to a content access table 142 that sets the access permissions for that particular multimedia file.

So that legitimate users can access the media center even if the primary authentication token (passwords) are lost or forgotten, answers to a secondary security question may be requested. These questions are stored in a SECURITYQUESTION table 144, which is referenced by an attribute of the APPUSER table 136. The answer to the selected question specified is stored in a separate attribute of the same APPUSER table 136.

The APPUSER table 136 is also used to log various events occurring on the account, and includes a number of attributes referencing tables that store log information. For instance, a MEDIAHISTORY table 146 records the last ten multimedia content items accessed by the user. Furthermore, a MEDIACENTERHISTORY table 148 records the last ten media centers accessed by the user. A MEDIAUSAGE table 150 is used to track each of the multimedia content items retrieved under the account. Whenever the user logs in to the account, that event is likewise stored and associated with the pertinent record of the APPUSER table 136. In particular, a SIGNONHISTORY table 152, as referenced by an attribute of the APPUSER table 36, records the details, including the Internet Protocol (IP) address, and the city and state corresponding to that IP address. The IP address is stored in a referenced IPLOCATION table 154, while the city and state are stored in a CITY table 156 and a STATE table 158, respectively.

In addition to the foregoing user-specific logging functions, it is contemplated that the multimedia content delivery and management system 10 also include system-wide logging functions. Again, those having ordinary skill in the art will be able to ascertain the appropriate data structures that must be defined. Amongst the summary reports that can be generated include the total access request per day, the average number of access requests per session, the number of new user registrations, the number of hits per category of users, traffic sources, and so forth.

As noted above, a number of additional features that enhance the user experience are contemplated, such as setting playlists for sequencing the playback the multimedia content, and bookmarking multimedia content. Those having ordinary skill in the art will be able to readily ascertain the implementation specifics of such tables, and proper linking/referencing to the above-described database structures, including the CONTENT table 60, the MEDIA table 122, the MEDIACTR table 120, and the APPUSER table 136.

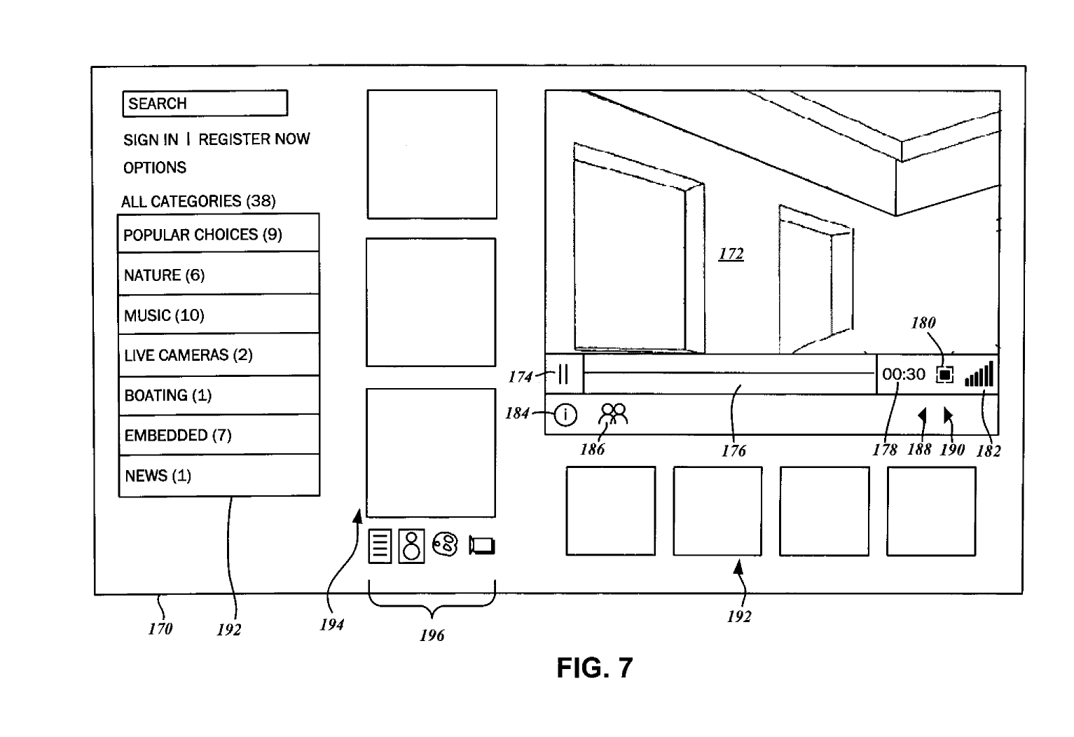

With reference again to the block diagram of FIG. 2, the multimedia content delivery and management system 10 also includes a browser interface module 49 that cooperates with the controller module 38 and the persistence module 48 to generate a multimedia playback interface 170 shown in FIG. 7. As noted previously, the interface 170 is rendered by the client web browser application, and is displayed as a conventional web page and divided into various sub-segments. Such functionality performed by the multimedia content delivery and management system 10 may also be referred to as a Rich Internet Application (RIA).

The most dominant part of the interface 170 is the main media playback window 172, within which the specified multimedia content is presented. The bottom portion of the playback window 172 includes various input buttons that control the playback of the multimedia content, such as a play/pause button 174, a scrubber bar 176 that shows the loading and playback progress of the multimedia content being presented in the playback window 172, a counter 178, a full screen mode button 180, and a volume button 182. Those having ordinary skill in the art will recognize the functional features of these buttons and indicators. In addition, there is an information button 184 that can be selected to display additional metadata for the currently displayed multimedia content, and a share button 186 to send the link to the multimedia content to other users. Furthermore, there is a back button 188 and a forward button 190 that allow for the advancement of the playlist, and load previous or subsequent multimedia content therein.

Below the main media playback window 172 is a related content browser 192 that lists a set of multimedia content on the system 10 that is related in some way to that being currently presented. The multimedia content is shown as its corresponding thumbnail. One way in which the related content browser 192 is populated is by retrieving other multimedia content that is similarly titled, or that has similar tags.

To the left of the main media playback window 172 is a content browser 192 that shows a listing of selectable categories, and a preview window 194 that shows thumbnails of the multimedia content in a selected category. In addition, by selecting one of the content type buttons 196, the multimedia content shown in the preview window 194 can be limited to specific types, including documents, audio, video, and images.

According to one embodiment of the present invention, the browser interface module 49 includes a user interface library 160 such as the jQuery library. As will be recognized, the jQuery library includes HTML document traversing event handling, animating, and Asynchronous JavaScript (AJAX) interactions. Prior to loading the multimedia content, appropriate client-side code checks for the existence of the necessary multimedia playback plug-ins in the browser application.

While particularities of the multimedia playback interface 170 have been presented, it will be appreciated that any suitable interface to browse the multimedia content may be substituted without departing from the scope of the present invention. In some instances, rather than showing the full interface as in FIG. 7, a minimal interface that shows just the media playback window 172, may be more appropriate.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A system for delivering multimedia content over a network to a client browser, the system comprising:
a first hypertext transfer protocol server connected to the network and in communication with the client browser;
a database server with the multimedia content being stored thereon in a structured arrangement;
an application server in communication with the hypertext transfer protocol server and the database server; and
a remote application executable on the application server, the remote application including:
a controller module receptive to selection input from the client browser;
a persistence module interfacing the controller module to the structured arrangement in the database server, the multimedia content corresponding to the selection input being retrievable with a query from the controller module to the persistence module; and
a browser interface module generating a multimedia playback interface rendered by the client browser, the retrieved multimedia content being transmitted to the client browser and displayed within the rendered multimedia playback interface;
wherein the remote application is linkable from a cooperating second hypertext transfer protocol server, the multimedia playback interface being embeddable within a document generated by the second hypertext transfer protocol server and rendered by the client browser.

2. The system of claim 1, wherein the multimedia content is selected from a group consisting of: video data, audio data, graphic data, and textual data.

3. The system of claim 1, wherein the multimedia content is stored as a plurality of data files, each data file having metadata associated therewith and stored in the structured arrangement.

4. The system of claim 3, wherein a one of the metadata is selected from a group consisting of: category, name, keyword, language, sharing privilege, and access privilege.

5. The system of claim 3, further comprising an administrative submodule within the controller module, the metadata being editable through the administrative submodule.

6. The system of claim 5, wherein the administrative submodule is receptive to an upload of a multimedia content data file, the multimedia content file being stored in the structured arrangement and assigned a name metadata and a category metadata.

7. The system of claim 1, wherein the database server is a logical set of a plurality of coordinated data processing systems collectively defining the structured arrangement.

8. The system of claim 1, wherein the structured arrangement on the database server is defined in a relational database system.

9. The system of claim 1, wherein the first hypertext transfer protocol server, the database server, and the application server are located within a first local area network remote from the second hypertext transfer protocol server.

10. The system of claim 1, wherein the first hypertext transfer protocol server, the database server, the application server, and the second hypertext transfer protocol server are located within a first local area network.

11. The system of claim 1, wherein the remote application further includes a security module limiting access to the multimedia content based upon access credentials submitted by the client browser.

12. The system of claim 1, wherein the browser interface module queries the client browser for available multimedia content rendering external plug-ins.

13. The system of claim 1, wherein the application server includes a network bandwidth throttling module.

14. A multimedia content delivery system cooperating with a first network service entity and a second network service entity, the system comprising:
a content database with a first set of multimedia content data files associated with the first network service entity and a second set of multimedia content data files associated with the second network service entity; and
an application server generating a first multimedia interface rendered within a first document served by the first network service entity and a second multimedia interface rendered within a second document served by the second network service entity, each of the first and second multimedia interfaces being restricted to displaying a respective one of the first set of multimedia content data files and the second set of multimedia content data files retrievable from the content database.

15. The system of claim 14, wherein the multimedia content data files are selected from a group consisting of: video data, audio data, graphic data, and textual data.

16. The system of claim 14, wherein each multimedia content data file has metadata associated therewith.

17. The system of claim 16, wherein the multimedia content data files are presented in an arrangement within the respective first and second multimedia interfaces according to its associated metadata.

18. The system of claim 14, wherein the first network service entity and the second network service entity are independently administered.

19. The system of claim 14, wherein the first network service entity and the second network service entity are remote from the content database and the application server.
